(19) United States
(12) Patent Application Publication
(10) Pub. No.: US 2011/0131500 A1
(43) Pub. Date: Jun. 2, 2011

(54) SYSTEM AND METHOD OF PROVIDING ENHANCED LISTINGS

(75) Inventor: Chikai J. Ohazama, San Francisco, CA (US)

(73) Assignee: Google Inc., Mountain View, CA (US)

(21) Appl. No.: 12/627,313

(22) Filed: Nov. 30, 2009

(51) Int. Cl. G06F 15/16; G06F 3/048; G06Q 30/00; G06Q 50/00

(52) U.S. Cl. 715/738; 709/203; 705/34

(57) ABSTRACT

A system and method is provided that enhances local listings for entities associated with web-content. In one aspect, a server generates entity listings based on content associated with the entity. Content associated with the entity and not incorporated into a listing may be used to generate a enhancement content. Enhancement content may be used to promote the entity. For example, an entity or its representative may identify its listing and select an enhancement to be displayed with the listing. The system will associate the entity or listing with the enhancement. When a user requests listings, the system will identify listings are associated with enhancements and provide the listings and enhancements to the users. An enhancement may be displayed as a tag proximate to the associated entity's listing information as well as a tag proximate to the associated entity's location on a map.

### BACKGROUND OF THE INVENTION

Systems which provide search and advertising services such as Google Search and Google Map Search allow users to search for business listings associated with a geographic location or area. For example, a user may enter search terms including a business type and a location and receive a plurality of business listings. Unlike advertisements, which involve selection by businesses and various fees, business listings are identified from information available on the system, for example websites or directories. Each listing may include various types of information such as addresses, phone numbers, review information, links to related websites, and images.

Advertisements are often ranked according to the various agreements between the advertising business and the search provider, whereas listings are often ranked by the provider according to pre-determined algorithms such as proximity to a geographic location, relevance to the search terms, or click-through rates.

These systems predetermine which type of information will be displayed for each listing. The displayed information may be selected based on the types of information available, click-through rates, or various algorithms. As a result, listings within the same result list may include different information. For example, hotel listings may include prices while restaurant listings may include user reviews. Two business listings for similar businesses may include different types of information depending on what information is available. Thus, in a list of results of restaurant listings, one restaurant listing may include an image of the restaurant while another restaurant listing may include a portion of a user review and a link to the entire review.

Businesses interested in highlighting or enhancing business listings are thus required to commit resources to producing advertisements. However, advertisements are generally displayed as removed from search results. This can result in inefficient advertising.

### BRIEF SUMMARY OF THE INVENTION

Systems and methods according to aspects of the invention provide users with enhanced listings that may be displayed on a display device. In one aspect, a method of is provided which provides an enhanced local listing for presentation on a display of a client device on a computer network. The method comprises identifying, by a server, content information associated with an entity, the content information including primary information for generating a local listing and secondary information; providing, to the entity, an option to select an enhancement that includes at least one item of secondary information; receiving the selected enhancement; associating the entity with the selected at least one enhancement; and storing the association in memory accessible by the server. The method also includes receiving a request for information from the client device; generating, based on the request for information, a plurality of local listings, each local listing associated with a different entity; and transmitting, if a local listing of the plurality of local listings is associated with the entity, the plurality of local listings and the selected enhancement for display on the client device.

In one example, the method further includes requesting payment from the entity in response to receiving the selected enhancement.

In another example, the request for information is associated with geographic location information, and the method further includes selecting, from a plurality of map tiles, a map tile representing the geographic location information; identifying a geographic location of the entity; and transmitting the map tile, the geographic location of the entity, an indication that a first tag representing the selected enhancement is to be displayed on the map tile, and an indication that a second tag representing the selected at least one enhancement is to be displayed proximate to the local listing associated with the entity. The method may also include receiving, by the client device, the map tile, the geographic location of the entity the indication that the selected enhancement is to be displayed on the map tile, the indication that the first tag is to be displayed on the map tile, and the indication that the second tag is to be displayed proximate to the local listing; and displaying, on the display device of the client device, the map tile, the first tag, and the second tag.

In one alternative, the first tag includes an icon with text. In another alternative, the second tag includes an icon hyperlinked to the at least some secondary information associated with the selected enhancement. In a further alternative, the second tag includes an icon and a description of the selected at least one enhancement.

In a further example, the request for information is a search query. In an alternative example, the request for information is a map search request.

In another embodiment, a server apparatus for providing enhanced local listings to a client device over a computer network. The server includes a memory for storing information, including a plurality of business listings; and a processor. The processor is configured to identify, content information associated with an entity, the content information including primary information for generating a local listing and secondary information; provide, to the entity, an option to select an enhancement that includes at least one item of secondary information; receive the selected enhancement; associate the entity with the selected at least one enhancement; and store the association in memory accessible by the server. The processor is also configured to receive a request for information from the client device; generate, based on the request for information, a plurality of local listings, each local listing associated with a different entity; transmit, if a local listing of the plurality of local listings is associated with the entity, the plurality of local listings and the selected enhancement for display on the client device.

In one example, the processor is further configured to request billing information upon receipt of the identification of the specified enhancement. In an alternative example, the processor is further configured to request payment upon receipt of the identification of the specified enhancement.

In one example, the processor is further programmed to transmit the received content with the at least item of secondary information. In an alternative example, the at least one item of secondary information includes a photo.

In a further embodiment, a client device is provided for displaying enhanced local listings to a user. The client device includes a processor, a user input device for providing data to the processor, a display device for displaying data processed by the processor in accordance with instructions, and memory for storing data accessed by the processor. The processor is configured to transmit a request for information, including a search term and geographic information; receive a set of local listings based on the search term and the geographic information, each local listing in the set of local listings associated with an entity and information associated with the entity, the set of local listings including an enhanced local listing associated with an enhancement, wherein the enhancement promotes content associated with a given entity and the content includes information other than the information included in the local listing, a map tile based on the geographic information, an indication that a first tag associated with the enhancement is to be displayed with the map tile proximate to a geographic location for the enhanced local listing, and an indication that a second tag associated with the enhancement is to be displayed proximate to the enhanced local listing; and display, on the display device, the set of local listings, the first tag on the map tile proximate to the geographic location associated with the enhanced listing, and the second tag proximate to text of the enhanced local listing.

In one example, the processor is further configured to receive content associated with the first tag and display the received content associated with the first tag.

In another example, the received content is a link to a website including user reviews.

In a further example, the enhanced local listing is associated with a particular business and the received content is a link to a website associated with the particular business.

In an additional example, the first tag is different from the second tag.

In a further additional example, the client device is a mobile phone.

### BRIEF DESCRIPTION OF THE DRAWINGS

FIG. 1 is a functional diagram of a system in accordance with an aspect of the invention.

FIG. 2 is a pictorial diagram of a system in accordance with an aspect of the invention.

FIG. 3A is a functional diagram of information in accordance with an aspect of the invention.

FIG. 3B is a functional diagram of information in accordance with an aspect of the invention.

FIG. 4 is an exemplary screen shot in accordance with an aspect of the system and method.

FIG. 5 is an exemplary screen shot in accordance with an aspect of the invention.

FIG. 6 is an exemplary screen shot in accordance with an aspect of the invention.

FIG. 7 is an exemplary screen shot in accordance with an aspect of the invention.

FIG. 8 is an exemplary screen shot in accordance with an aspect of the invention.

FIG. 9 is an exemplary screen shot in accordance with an aspect of the invention.

FIG. 10 is a flow chart in accordance with aspects of the invention.

### DETAILED DESCRIPTION

A system and method is provided that enhance local listings for entities associated with web-content. In one aspect, a server generates entity listings based on content associated with the entity. Content associated with the entity and not incorporated into a listing may be used to generate a enhancement content. Enhancement content may be used to promote the entity. For example, an entity or its representative may identify its listing and select an enhancement to be displayed with the listing. The system will associate the entity or listing with the enhancement. When a user requests listings, the system will identify listings are associated with enhancements and provide the listings and enhancements to the users. An enhancement may be displayed as a tag proximate to the associated entity's information as well as a tag proximate to the associated entity's location on a map.

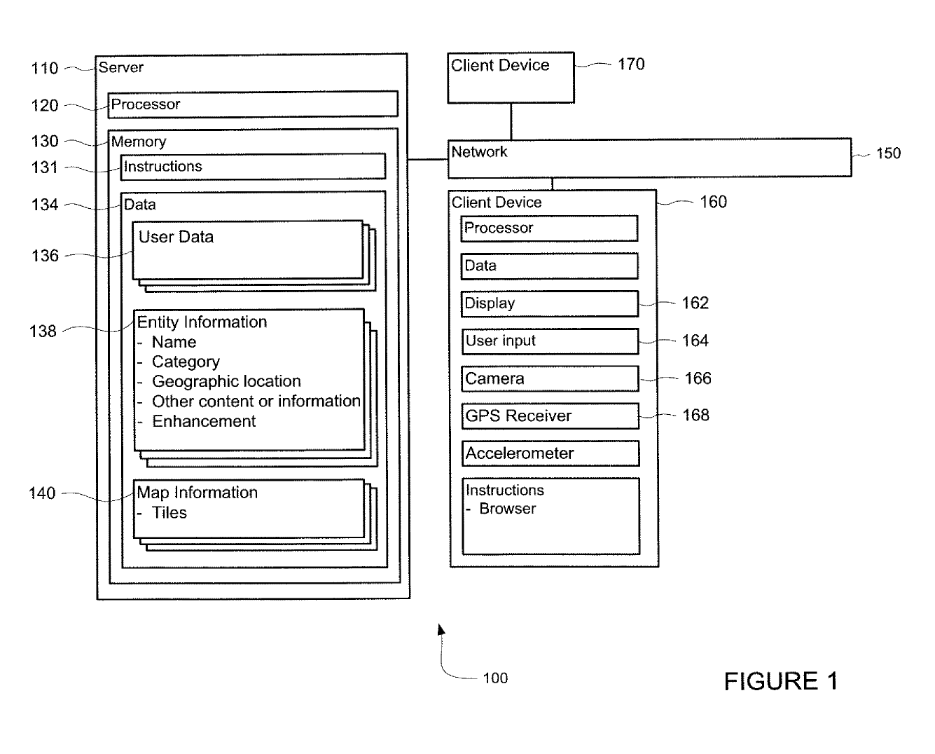

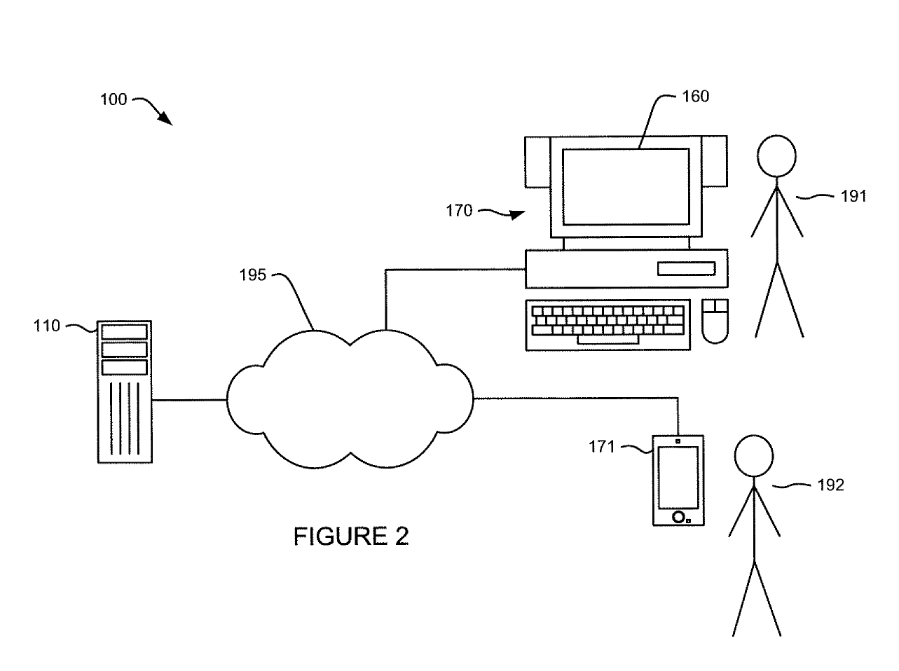

As shown in FIGS. 1-2, a system 100 in accordance with one aspect of the invention includes a computer 110 containing a processor 120, memory 130 and other components typically present in general purpose computers.

The memory 130 stores information accessible by processor 120, including instructions 132 and data 134 that may be executed or otherwise used by the processor 120. The memory 130 may be of any type capable of storing information accessible by the processor, including a computer-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 132 may be any set of instructions to be executed directly (such as machine code) or indirectly (such as scripts) by the processor. For example, the instructions may be stored as computer code on the computer-readable medium. In that regard, the terms “instructions” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

The data 134 may be retrieved, stored or modified by processor 120 in accordance with the instructions 132. For instance, although the system and method is not limited by any particular data structure, the data may be stored in computer registers, in a relational database as a table having a plurality of different fields and records, XML documents or flat files. The data may also be formatted in any computer-readable format. By further way of example only, image data may be stored as bitmaps comprised of grids of pixels that are stored in accordance with formats that are compressed or uncompressed, lossless (e.g., BMP) or lossy (e.g., JPEG), and bitmap or vector-based (e.g., SVG), as well as computer instructions for drawing graphics. The data may comprise any information sufficient to identify the relevant information, such as numbers, descriptive text, proprietary codes, references to data stored in other areas of the same memory or different memories (including other network locations) or information that is used by a function to calculate the relevant data.

The processor 120 may be any conventional processor, such as processors from Intel Corporation or Advanced Micro Devices. Alternatively, the processor may be a dedicated controller such as an ASIC. Although FIG. 1 functionally illustrates the processor and memory as being within the same block, it will be understood by those of ordinary skill in the art that the processor and memory may actually comprise multiple processors and memories that may or may not be stored within the same physical housing. For example, memory may be a hard drive or other storage media located in a server farm of a data center. Accordingly, references to a processor or computer will be understood to include references to a collection of processors or computers or memories that may or may not operate in parallel.

The computer 110 may be at one node of a network 150 and capable of directly and indirectly communicating with other nodes of the network. For example, computer 110 may comprise a web server that is capable of communicating with client devices 160 and 170 via network 150 such that server 110 uses network 150 to transmit and display information to a user 190 on display 162 of client device 170. Server 110 may also comprise a plurality of computers that exchange information with different nodes of a network for the purpose of receiving, processing and transmitting data to the client devices. In this instance, the client devices will typically still be at different nodes of the network than any of the computers comprising server 110.

Network 150, and intervening nodes between server 110 and client devices, may comprise various configurations and use various protocols including the Internet, World Wide Web, intranets, virtual private networks, local Ethernet networks, private networks using communication protocols proprietary to one or more companies, cellular and wireless networks (e.g., WiFi), instant messaging, HTTP and SMTP, and various combinations of the foregoing. Although only a few computers are depicted in FIGS. 1-2, it should be appreciated that a typical system can include a large number of connected computers.

Each client device may be configured similarly to the server 110, with a processor, memory and instructions. Each client device 160 or 170 may be a personal computer intended for use by a person 191-192, and have all of the components normally used in connection with a personal computer such as a central processing unit (CPU), memory (e.g., RAM and internal hard drives) storing data and instructions, an electronic display 162 (e.g., a monitor having a screen, a small LCD touch-screen, a projector, a television, a computer printer or any other electrical device that is operable to display information), user input 164 (e.g., a mouse, keyboard, touch-screen or microphone), camera 166, GPS receiver 168, speakers, a network interface device, and all of the components used for connecting these elements to one another.

Although the client devices 160 and 170 may each comprise a full-sized personal computer, they may alternatively comprise mobile devices capable of wirelessly exchanging data with a server over a network such as the Internet. By way of example only, client device 170 may be a wireless-enabled PDA or a cellular phone capable of obtaining information via the Internet. The user may input information using a small keyboard (in the case of a Blackberry phone), a keypad (in the case of a typical cell phone) or a touch screen (in the case of a PDA). Indeed, computers in accordance with the systems and methods described herein may comprise any device capable of processing instructions and transmitting data to and from humans and other computers including general purpose computers, network computers lacking local storage capability, and set-top boxes for televisions.

Although certain advantages are obtained when information is transmitted or received as noted above, aspects of the invention are not limited to any particular manner of transmission of information. For example, in some aspects, information may be sent via a medium such as an optical disk or portable drive. In other aspects, the information may be transmitted in a non-electronic format and manually entered into the system. Yet further, although some functions are indicated as taking place on a server and others on a client, various aspects of the system and method may be implemented by a single computer having a single processor.

Returning to FIG. 1, user data 136 identifies users of the systems, i.e., any entity that interacts with the system and method such as businesses or people. For example, one user may be the owner or administrator of a restaurant named “Joe's Pizza”.

The server 110 may also access entity information identifying local businesses, clubs, or other objects or features associated with particular geographic locations. For example, an entity may be associated with a name (such as a company's name), a category (such as “pizza”, “Italian restaurant” or “ballpark”), a geographic location (such as “123 Main Street” or latitude and longitude), and various other types of information. An entity may also be associated with links to the entity's website, user reviews, images, phone numbers, links to additional information pages, or, as will be described in more detail below, enhancements.

Images may include, for example, images related to the entity. For example, if the entity is a business, the business's entity information may include user uploaded pictures of the interior or exterior of the business, images of the goods or services provided by the business, or street level images. A street level image may be an image of geographic objects that was captured by a camera at an angle generally perpendicular to the ground or objects at or near ground level (e.g., around the level of the first floor of a building). Street level image data may represent various geographic objects such as buildings, sidewalks and streets and may be used to create panoramic street-level images by stitching together a plurality of photographs taken from different camera angles.

Entity information may be compiled by automatically gathering information from websites, telephone directories or other content sources.

Entities may refer to other geographically-located objects in addition to or instead of businesses. For example, entities may also include points of interest (“POI”), individual's homes, landmarks, roads, bodies of land or water, items located in a store, items that can be moved to different locations etc. Therefore, while many of the examples below refer to businesses, most aspects of the system and method are not limited to any particular type of entity.

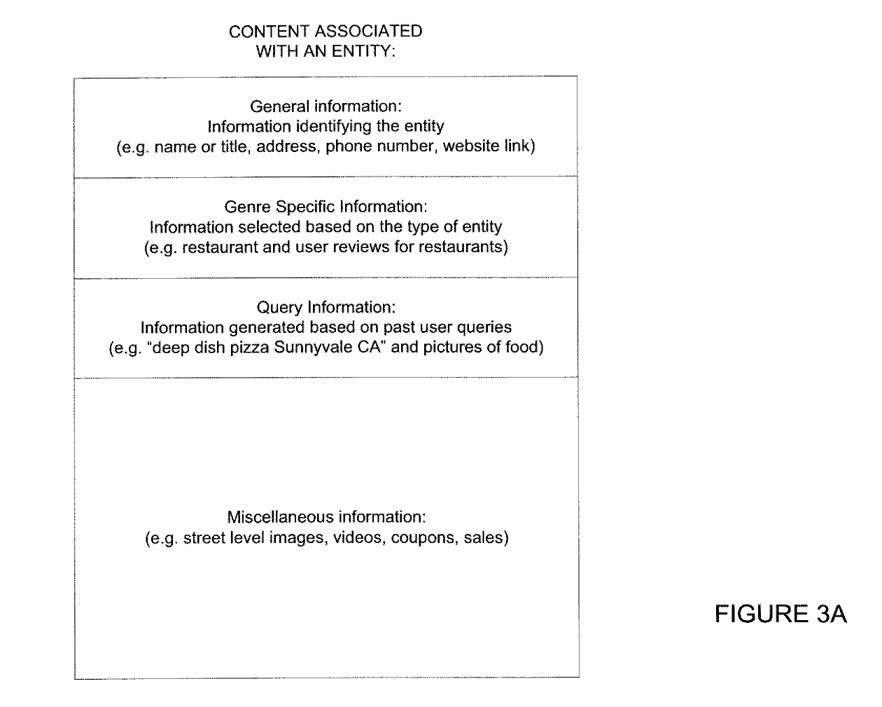

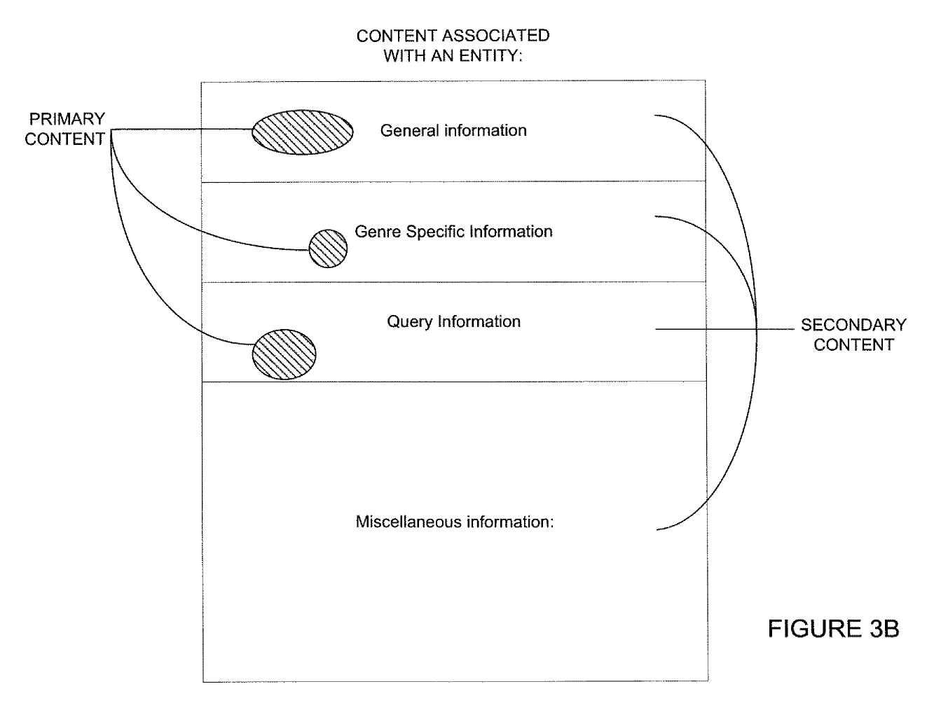

As shown in FIG. 3A, server 110 may access various types of information related to an entity. For example, an entity may be associated with general information, such as name, phone number, address, or website. The entity may also be associated with genre specific information, such as if the entity is a restaurant, the entity may be associated with user reviews of the restaurant. The entity may be associated with query information, such as, information from past user queries information. For example, if a number of users searched for “deep dish pizza Sunnyvale, Calif.” and selected images of the food, this information may be associated with entities related to deep dish pizza in Sunnyvale Calif.

In response to a request for information, server 110 may use entity information to generate listings. Listings may be determined algorithmically by the server, for instance based upon usage or advertising metrics. For example, as shown in FIG. 3B, server 110 may generate a listing for a particular entity by selecting content associated with general, genre specific, and query information (the shaded regions). It will be understood that although only general, genre, and query information are selected in the example, any single or combination of the four exemplary content types may be selected for a listing. The content selected for use in a listing may be designated as “primary content.” Content not selected for use in a listing may be designated as “secondary content.” As will be described in more detail below, secondary content may be used to generate enhancements.

Listing information may also be stored or updated by users. For instance, users may enter or edit the listing information themselves via web pages served by the server 110. Accordingly, the listing information may be obtained from various sources and may contain potentially overlapping information, such as one category that is managed by the operator of the server and another category that is obtained from third parties (e.g., yellow pages). In many cases, there will be a single listing for each different entity. However, it will be understood that the same entity may be associated with many different listings, and that a single listing may be associated with many different entities.

Returning to FIG. 1, server 110 may store map-related information 140, at least a portion of which may be transmitted to a client device. For example and as shown in FIG. 1, the server may store map tiles, where each tile comprises a map image of a particular geographic area. A single tile may cover an entire region such as a state in relatively little detail and another tile may cover just a few streets in high detail. In that regard, a single geographic point may be associated with multiple tiles, and a tile may be selected for transmission based on the desired level of zoom. The map information is not limited to any particular format. For example, the images may comprise street maps, satellite images, or a combination of these, and may be stored as vectors (particularly with respect to street maps) or bitmaps (particularly with respect to satellite images).

The various map tiles are each associated with geographical locations, such that the server 110 is capable of selecting, retrieving and transmitting one or more tiles in response to receiving a geographical location.

Aspects of the invention may process locations expressed in different ways, such as latitude/longitude positions, street addresses, street intersections, an x-y coordinate with respect to the edges of a map (such as a pixel position when a user clicks on a map), names of buildings and landmarks, and other information in other reference systems that is capable of identifying a geographic locations (e.g., lot and block numbers on survey maps). Moreover, a location may define a range of the foregoing. In one example, a system and method may further translate locations from one reference system to another. For instance, the server 110 may access a geocoder to convert a location identified in accordance with one reference system (e.g., a street address such as “1600 Amphitheatre Parkway, Mountain View, Calif.”) into a location identified in accordance with another reference system (e.g., a latitude/longitude coordinate such as (37.423021°, −122.083939)). In that regard, it will be understood that exchanging or processing locations expressed in one reference system, such as street addresses, may also be received or processed in other references systems as well.

A user may access server 110 and identify itself as the owner or administrator of an entity such as a business. For example, an entity user may be the owner of a restaurant named “Joe's Pizza.” The entity user operating a client device, such as client device 160, may provide server 110 with a name, address, phone number, or other information associated with the entity.

Server 110 may use this information to verify that the user is properly associated with the entity. The system may use phone verification, for example, calling a number provided by the entity user and verifying that it is associated with the entity. Various other techniques may also be used including analyzing available entity records.

Server 110 may use information received from the client device to identify and update a listing associated with the entity. For example, if the server receives information such as name “Joe's Pizza” and phone number “(555) 321-6780,” server 110 may identify the entity user, client device, or the entity associated with the entity user with the listing “Joe's Pizza, 25 Fourth Street, (555) 321-6789.” Server 110 may also associate other information, for example additional information received from the entity user, with the listing.

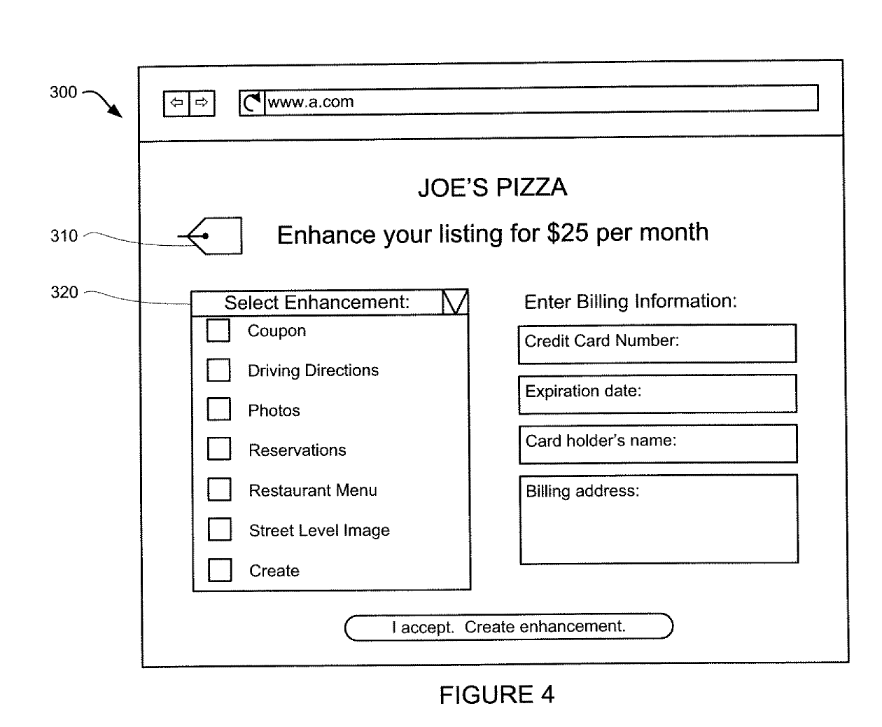

Server 110 may send the client device enhancement options. Enhancement options may be generated by the server from entity information not already included in a listing, for example, secondary content of FIG. 3B. Accordingly, enhancement options may include hyperlinks to commercial offers or incentives such as coupons, driving directions, photos, reservations, restaurant menus, street level images, data feeds, or any variety of media or information about the entity or location. As shown in FIG. 4, the client device may employ a graphical user interface 300 to display the name of the business entity, “Joe's Pizza” and options to enhance the listing for a set fee. As shown, enhancement tag 310 may be displayed. The enhancements may be provided in a number of ways such as a drop down list 320, a list with check boxes, a box to be filled in by the user, or any similar method.

An entity user may select an enhancement and provide billing information. The entity user may select, for example by clicking on a button, to accept the selection and create an enhancement. The server may charge the entity user a fee, for example, for selecting the enhancement, when the enhancement is displayed in conjunction with the listing, or when a search user requests the enhancement or billing may be done by a separate server or billing server. When an enhancement option is selected and accepted, the server may request further information. For example, if the entity user selects “restaurant menu” as an enhancement, the server may identify the relevant secondary content, for example, a link to a webpage including or image of PDF of a restaurant menu. In another example, the server may require the user to upload content or provide a link to the content. In yet another example, an entity user may select to “create” an enhancement. Server 110 may allow the entity user to design a personalized enhancement with content provided by the server or the user.

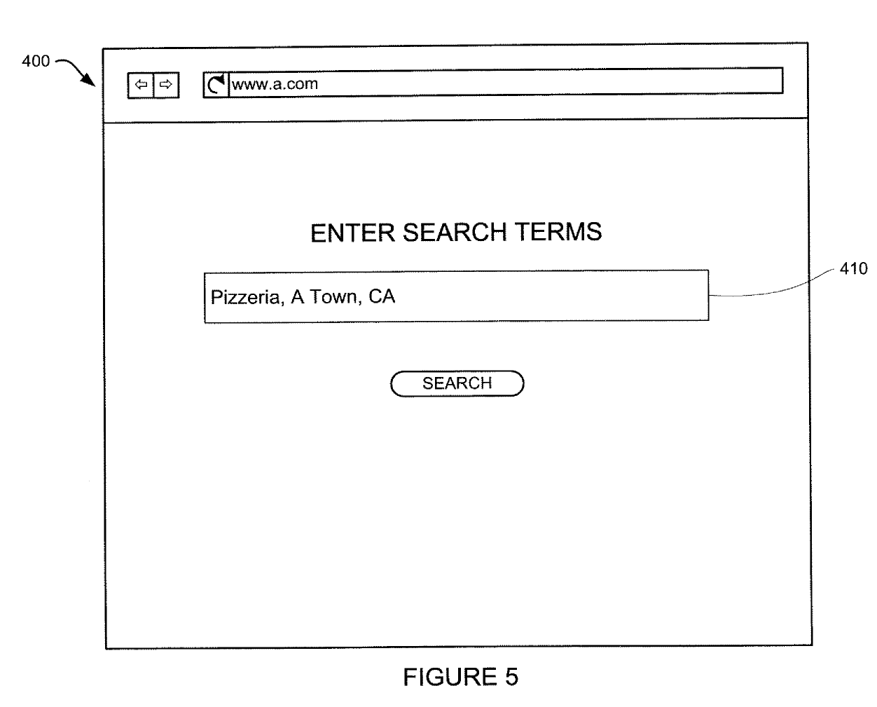

The server may associate the selected enhancement and content with the particular listing. Server 110 may also store the association in memory accessible by the server. The stored association may be used when subsequently providing content to users. For instance, a user operating a client device may request local listings from server 110. For example, a search user may use one or more search terms associated with an entity type in conjunction with geographical information. As shown in FIG. 5 with interface 400, the search user may input box 410 to provide the server with search terms such as “pizzeria” which identifies a entity type and “A Town, CA” which indicates a location. As explained above, locations may be identified in any number of ways and are not limited to the “city, state” format of the example. In another example, geographic information may include an IP address or GPS coordinates associated with the client device or past geographic queries by the user. The search user may enter the search terms and select, for example, a “search” or “go” button to initiate the search.

The server may use the search terms to identify search results as well as enhancements. For example, server 110 may identify entities associated with the search term “pizzeria” near the location “A Town, CA.” The server may generate listings for the identified entities based on the entity information associated with each identified information. Accordingly, server 110 may include primary content in the listing results, for example, business names, addresses, or phone numbers as described above. The server may also determine which of the listing results are associated with enhancements.

The server may provide map information regarding each business listing. For example, the business listing results may also be associated with a geographic location on a map. Server 110 may identify an appropriate map tile, based on the listing results and an approximate map location of the listing.

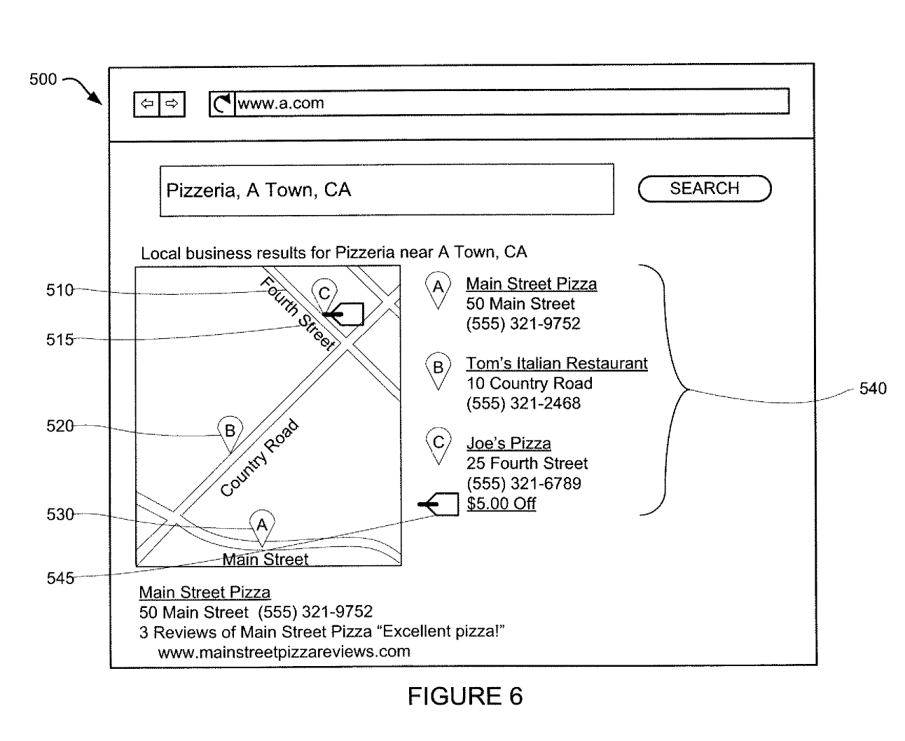

The server may provide the business listing results, enhancements, and map information to the client device. The client device may receive and display the information. As shown in FIG. 6 with interface 500, client device may display various information in a browser window. For example, the display may include a set of business listing results 540 which include business names, links to various websites, addresses, and phone numbers. The client device may use map information from server 110 to display map indicators 510, 520, and 530 (e.g. “A,” “B,” and “C”) which identify approximate locations of the businesses on a map. Additional search results or generic business listings may also be provided below the map and business listing results. It will be appreciated that while only three results and three map indicators are shown in the example, any number of results and/or map indicators may be provided and displayed.

Where server 110 has identified an enhancement, the client device may display a tag, such as an icon or other visual indicator which represent the enhancement. As shown in FIG. 6, the “Joe's Pizza” listing, as well as map indicator “C” associated with the listing, are both displayed with tags 515 and 545 shown as price tags. Each tag 515 and 545 indicates the enhancement selected by the business. In the example, the tag associated with the listing for “Joe's Pizza” indicates a $5 coupon. As shown, two tags may indicate a single enhancement where one tag may be associated with the textual business listing and the other tag may be associated with the map location of the business.

Tags may also include links to additional content. As shown in FIG. 6, the map tag, listing tag, or “$5.00 Off” tag may link to a coupon at the business' website or a website with coupon offers.

The enhancements may not affect which listings are displayed or the order in which the listings are displayed.

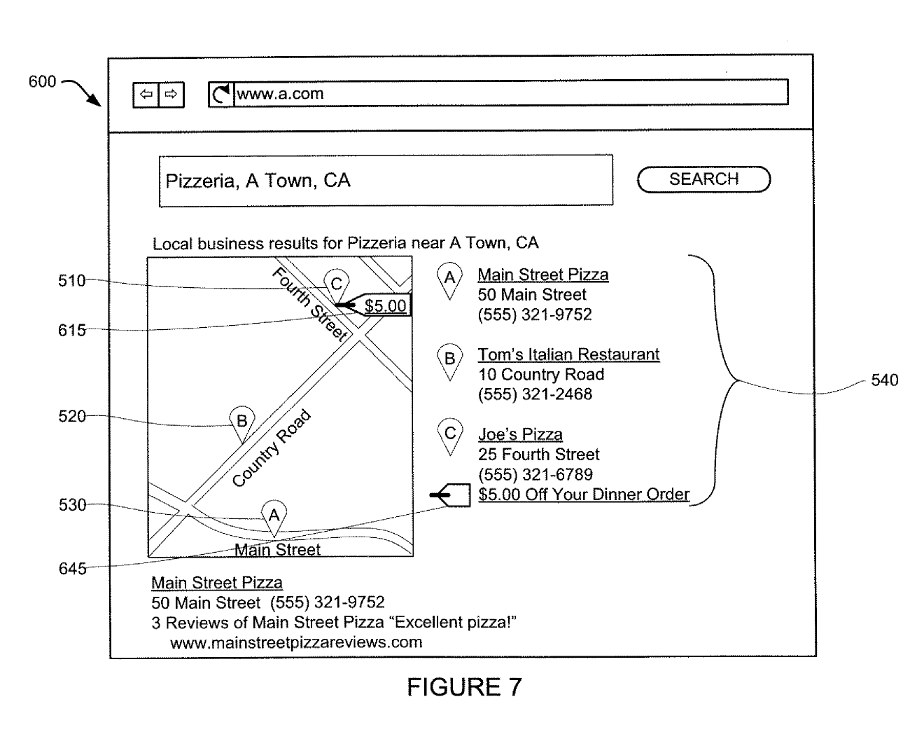

The tags or icons themselves may include content. For example, the listing tag may include an indicator of what the enhancement is, which may be abbreviated in the map view. As shown in user interface 600 of FIG. 7, the “Joe's Pizza” listing includes tag 645 “$5.00 Off Your Dinner Order” while the corresponding map tag 615 abbreviates this information to “$5.00.” Where there are multiple enhancements displayed in a single list of results, this additional information may help the user to differentiate between the enhancements.

Tags may also include icons or information which indicate different types of information. For example, a tag may include an icon which indicates that photos, street level images, driving directions, or other enhancements are available for the associated business.

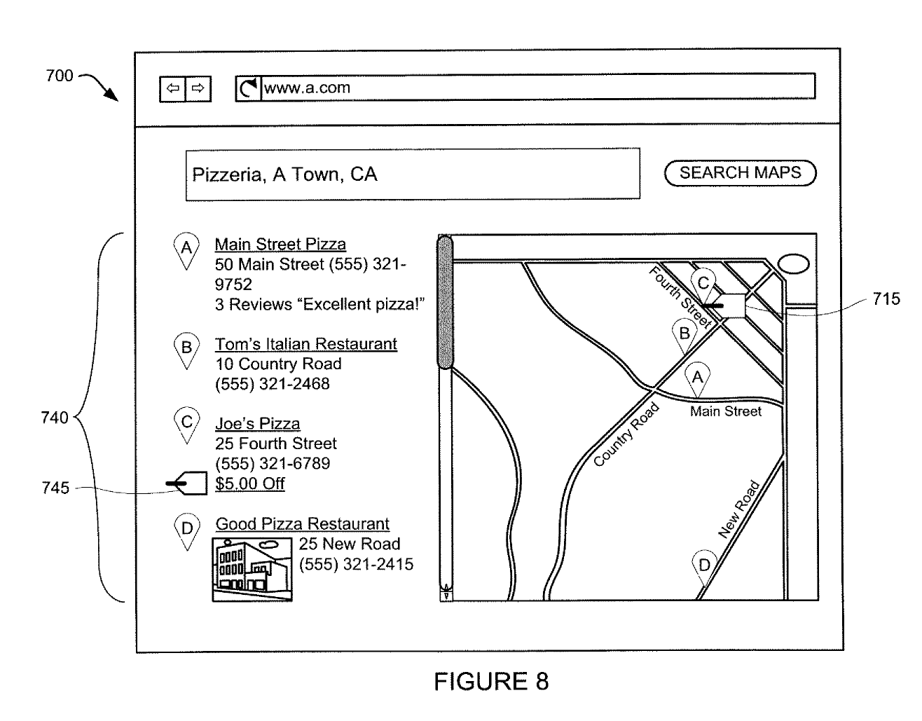

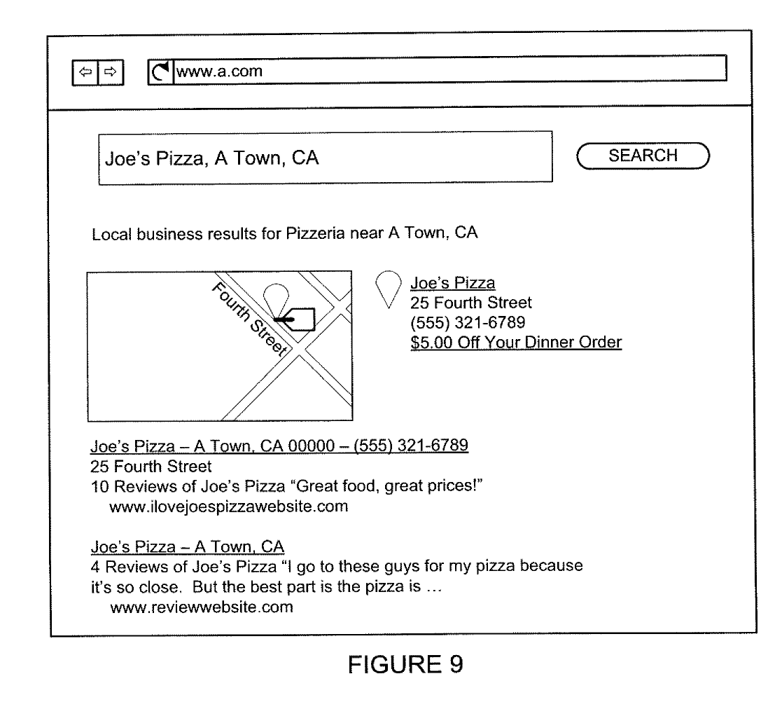

While the example above describes the use of the invention with a generic search for listings, aspects the invention may also be used in various other modes, for example, a map search. The user may enter map search terms and the server may identify listings, enhancements and map information as described above. As shown in user interface 700 of FIG. 8, map search results may display various information associated with the listings. For example, the display may include a set of listing results 740 generated from primary content as described above. In addition, as described above, the map search results may display any enhancements tags 715 and 745 associated with both a listing as well as the corresponding map indicator.

Where the server identifies a single listing result from the search terms, the client device may display the location of the entity on a map with our without the enhancement tag, as shown in FIG. 9.

In other aspects, functions described above as being performed by the server may be performed by the client device, and vice versa. For example, the client may determine the number of listing results to display. Alternatively, the client device and server perform and share different functions.

It will be understood that references herein to “search term” may include search terms that include more than one word, i.e., a search term may comprise multiple words, numbers, or other characters. It will be similarly understood that when a search query contains a search term (e.g. “pizza”), the query may contain only that one term or multiple terms (e.g., “pizza in Springfield”).

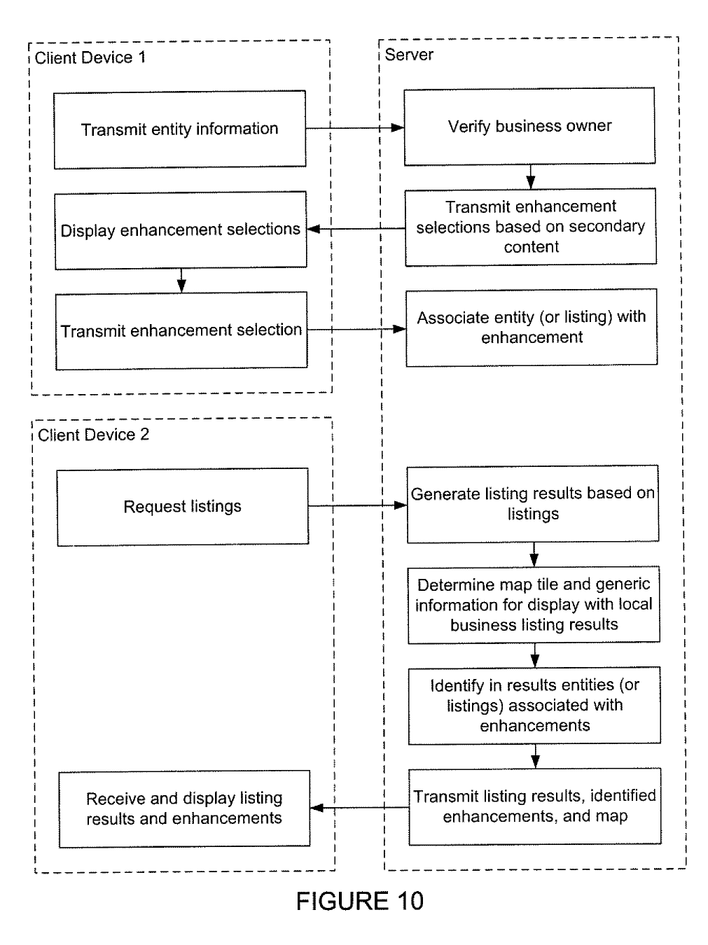

As shown in FIG. 10, a first client device and a second client device may interact with a server. The first client device may be associated with an entity user while the second client device may be associated with a search user. As explained above, the server may receive information from the entity user and use the information to verify the identify of the user. The server may identify content information associated with the entity and may identify primary information associated with the entity. The server may send enhancement options to the entity user based on secondary information. Once the entity user has selected an enhancement and submitted or otherwise chosen content to use, the server may associate the selected enhancement and the entity or the entity's listing.

The search user associated with client device 2 may request information from the server, for example, a search request for local listings. The server may identify listing results and an appropriate map information based on the search request and determine generic information for display with each listing result. Server may also identify whether any of the listing results are associated with an enhancement. This information, including the map information, business listing results, and enhancements may be transmitted to client device 2 for display to the search user.

It should be understood that the operations described herein do not need to be performed in the precise order listed. Rather, various operations can be handled in a different order or simultaneously.

It will be further understood that the sample values, types and configurations of data shown in the figures are for the purposes of illustration only. In that regard, systems and methods in accordance with aspects of the invention may include different data values, types and configurations, and may be provided and received at different times (e.g., via different web pages) and by different entities (e.g., some values may be pre-suggested or provided from different sources).

As these and other variations and combinations of the features discussed above can be utilized without departing from the invention as defined by the claims, the foregoing description of exemplary embodiments should be taken by way of illustration rather than by way of limitation of the invention as defined by the claims. It will also be understood that the provision of examples of the invention (as well as clauses phrased as “such as,” “e.g.”, “including” and the like) should not be interpreted as limiting the invention to the specific examples; rather, the examples are intended to illustrate only some of many possible aspects.

1. A method of providing an enhanced local listing for presentation on a display of a client device on a computer network, the method comprising:
identifying, by a server, content information associated with an entity, the content information including primary information for generating a local listing and secondary information;
providing, to the entity, an option to select an enhancement that includes at least one item of secondary information;
receiving the selected enhancement;
associating the entity with the selected at least one enhancement;
storing the association in memory accessible by the server;
receiving a request for information from the client device;
generating, based on the request for information, a plurality of local listings, each local listing associated with a different entity; and
transmitting, if a local listing of the plurality of local listings is associated with the entity, the plurality of local listings and the selected enhancement for display on the client device.

2. The method of claim 1, further comprising requesting payment from the entity in response to receiving the selected enhancement.

3. The method of claim 1, wherein the request for information is associated with geographic location information, and the method further comprises:
selecting, from a plurality of map tiles, a map tile representing the geographic location information;
identifying a geographic location of the entity; and
transmitting the map tile, the geographic location of the entity, an indication that a first tag representing the selected enhancement is to be displayed on the map tile, and an indication that a second tag representing the selected at least one enhancement is to be displayed proximate to the local listing associated with the entity.

4. The method of claim 3 further comprising:
receiving, by the client device, the map tile, the geographic location of the entity the indication that the selected enhancement is to be displayed on the map tile, the indication that the first tag is to be displayed on the map tile, and the indication that the second tag is to be displayed proximate to the local listing; and
displaying, on the display device of the client device, the map tile, the first tag, and the second tag.

5. The method of claim 4, wherein the first tag includes an icon with text.

6. The method of claim 4, wherein the second tag includes an icon hyperlinked to the at least some secondary information associated with the selected enhancement.

7. The method of claim 4, wherein the second tag includes an icon and a description of the selected at least one enhancement.

8. The method of claim 1, wherein the request for information is a search query.

9. The method of claim 1, wherein the request for information is a map search request.

10. A server apparatus for providing enhanced local listings to a client device over a computer network, the server comprising:
a memory for storing information, including a plurality of business listings; and
a processor configured to:
identify, content information associated with an entity, the content information including primary information for generating a local listing and secondary information; provide, to the entity, an option to select an enhancement that includes at least one item of secondary information; receive the selected enhancement; associate the entity with the selected at least one enhancement; and store the association in memory accessible by the server; and
receive a request for information from the client device;
generate, based on the request for information, a plurality of local listings, each local listing associated with a different entity; and transmit, if a local listing of the plurality of local listings is associated with the entity, the plurality of local listings and the selected enhancement for display on the client device.

11. The server of claim 10, wherein the processor is further configured to request billing information upon receipt of the identification of the specified enhancement.

12. The server of claim 10, wherein the processor is further configured to request payment upon receipt of the identification of the specified enhancement.

13. The server of claim 10, wherein the processor is further programmed to transmit the received content with the at least item of secondary information.

14. The server of claim 10, wherein the at least one item of secondary information includes a photo.

15. A client device for displaying enhanced local listings to a user, the client device comprising:
a processor;
a user input device for providing data to the processor;
a display device for displaying data processed by the processor in accordance with instructions; and
memory for storing data accessed by the processor;
wherein the processor is configured to:
transmit a request for information, including a search term and geographic information;
receive a set of local listings based on the search term and the geographic information, each local listing in the set of local listings associated with an entity and information associated with the entity, the set of local listings including an enhanced local listing associated with an enhancement, wherein the enhancement promotes content associated with a given entity and the content includes information other than the information included in the local listing, a map tile based on the geographic information, an indication that a first tag associated with the enhancement is to be displayed with the map tile proximate to a geographic location for the enhanced local listing, and an indication that a second tag associated with the enhancement is to be displayed proximate to the enhanced local listing; and
display, on the display device, the set of local listings, the first tag on the map tile proximate to the geographic location associated with the enhanced listing, and the second tag proximate to text of the enhanced local listing.

16. The client device of claim 15, wherein the processor is further configured to:
receive content associated with the first tag; and
display the received content associated with the first tag.

17. The client device of claim 16, wherein the received content is a link to a website including user reviews.

18. The client device of claim 16, wherein the enhanced local listing is associated with a particular business and the received content is a link to a website associated with the particular business.

19. The client device of claim 15, wherein the first tag is different from the second tag.

20. The client device of claim 15, wherein the client device is a mobile phone.
